(19) United States
(12) Patent Application Publication
(10) Pub. No.: US 2012/0067668 A1
(43) Pub. Date: Mar. 22, 2012

(54) FALL ARREST DEVICE AND KIT

(75) Inventor: Robert Rico, Ontario, CA (US)

(73) Assignee: RICO, INC., Ontario, CA (US)

(21) Appl. No.: 13/238,886

(22) Filed: Sep. 21, 2011

Related U.S. Application Data
(60) Provisional application No. 61/384,847, filed on Sep. 21, 2010.
(60) Provisional application No. 61/467,375, filed on Mar. 24, 2011.

(51) Int. Cl. A62B 35/00; F16M 13/02; A62B 1/16

(52) U.S. Cl. 182/3; 248/65

(57) ABSTRACT

At least one feature provides a fall arrest device for securing a user. The fall arrest device comprises a primary support member adapted to couple to a doorway, a security line having a first end adapted to couple to the primary support member, and a harness adapted to couple to a second end of the security line. The primary support member includes a first support member adapted to secure the primary support member to a first surface of a wall of the doorway, a second support member adapted to secure the primary support member to a second surface of the wall of the doorway, and at least one connecting member adapted to removeably couple the first support member and the second support member to each other. The connecting member may be adjusted to change a spacing between the first and second support members to secure the primary support member to the doorway.

### CLAIM OF PRIORITY

The present application for patent claims priority to U.S. Provisional Patent Application No. 61/384,847 entitled “Fall Arrest Device” filed Sep. 21, 2010, and U.S. Provisional Patent Application No. 61/467,375 also entitled “Fall Arrest Device” filed on Mar. 24, 2011, the entire disclosures of which are hereby expressly incorporated by reference herein.

### BACKGROUND

1. Field

Various embodiments of the disclosure pertain to fall arrest devices, methods, and kits that help secure a user from falling off of a ledge of a building while working on exterior portions of the building.

2. Background

Individuals that work on tall structures and multistory buildings, including for example, construction workers, painters, window removers, window cleaners, etc., need devices that provide them with safe access to exterior portions of a building. For example, a painter may need to safely access the exterior portion of a building in order to paint the exterior surface. As another example, a worker desiring to remove windows along the exterior surface of a building needs to work very closely to open edges of the building, and/or have access to portions of the exterior surface of the building. The means by which such access is provided also needs to ensure the safety of the worker by helping prevent falls. Typically, scaffolding and lifts trucks located along the exterior of the building are used to provide a relatively stable support surface for the worker to stand on and reach portions of the exterior of a building.

However, scaffolding and lift trucks are expensive and time consuming solutions for providing workers safe access to the exterior surface of a building. For example, a lot of labor and monetary expense is expended when erecting cumbersome and large scaffolding structures. Moreover, scaffolding is not readily portable to other sides of the building. Rather, the scaffolding must be disassembled and reassembled, or a separate scaffolding structure must be erected, along other sides of the building that need work.

Lift trucks also provide a relatively limited solution. They are expensive to own, lease, maintain, and operate. Operational expenses add up because licensed drivers are needed to operate the lift trucks. Moreover, lift trucks may be limited in their ability to provide a worker access to exterior surfaces of a building. For example, if the building is a skyscraper then some floors may be out of the lift truck's range. Renting additional lift trucks having longer range may be necessary making construction/repair of such buildings prohibitively expensive.

There is a need for devices, methods, and kits that safely and securely provide one or more workers access to portions of an exterior surface of a building, and are cost effective, inexpensive, and easy to use.

### SUMMARY

One feature provides a fall arrest device for securing a user, where the fall arrest device comprises a primary support member adapted to couple to a doorway, at least one security line having a first end adapted to couple to the primary support member, and at least one harness adapted to couple to a second end of the security line. The primary support member may be adapted to removeably couple to the doorway. In one embodiment, the first end of the security line is adapted to removeably couple to a security line connector. In another embodiment, the security line connector swivels about a security line connector pivot member. In one embodiment, the primary support member comprises a first support member adapted to secure the primary support member to a first surface of a wall of the doorway, a second support member adapted to secure the primary support member to a second surface of the wall of the doorway, and at least one connecting member adapted to removeably couple the first support member and the second support member to each other. In another embodiment, the primary support member further comprises a security line connector support mount having at least one security line connector, where the security line connector support mount is coupled to at least one of the first support member or the second support member, and the security line connector is coupled to the first end of the security line. In one embodiment, the connecting member is further adapted to adjust a spacing between the first support member and the second support member to secure the primary support member to the doorway. In yet another embodiment, the connecting member includes a connecting member fastener that adjusts the spacing between the first support member and the second support member. In yet another embodiment, the first support member is hollow and a cross section of the first support member has at least three sides.

Another feature provides a primary support member for a fall arrest device, where the primary support member comprises a first support member adapted to secure the primary support member to a first surface of a wall of a doorway, a second support member adapted to secure the primary support member to a second surface of the wall of the doorway, and at least one connecting member adapted to removeably couple the first support member and the second support member to each other, where the primary support member is adapted to removeably couple to the doorway. In one embodiment, at least a first end of the second support member is adapted to pass through a space between a door associated with the doorway and the second surface of the wall.

Another feature provides a fall arrest device kit comprising a plurality of fall arrest device components packaged together in an at least partially unassembled state for sale to consumers, wherein the fall arrest device components comprise a first support member adapted to secure to a first surface of a wall of a doorway, a second support member adapted to secure to a second surface of the wall of the doorway, and at least one connecting member adapted to removeably couple the first support member and the second support member to each other. In one embodiment, the kit further comprises a security line having a first end adapted to couple to a security line connector, and a harness adapted to couple to a second end of the security line.

Another feature provides a method of securing a user comprising securing a first support member to a first side of a wall having a doorway, securing a second support member to a second side of the wall having the doorway, and coupling the first support member to the second support member using at least one connecting member, the connecting member passing through the doorway. In one embodiment, the method further comprises coupling a first end of a security line to a security line connector, where the security line connector is coupled to at least one of the first support member or the second support member. In another embodiment, the method further comprises tuning a connecting member fastener to adjust a spacing between the first support member and the second support member to secure the first support member to the first side of the wall and the second support member to the second side of the wall.

Another feature provides a fall arrest device comprising a means for securing a primary support member to a first side of a wall having a doorway, a means for securing the primary support member to a second side of the wall having the doorway, and a means for coupling the means for securing the primary support member to the first side of the wall to the means for securing the primary support member to the second side of the wall, the means for coupling passing through the doorway. In one embodiment, the fall arrest device further comprises a means for coupling a first end of a security line to the primary support member, where the means for coupling the first end of the security line is coupled to at least one of the means for securing the primary support member to the first side of the wall or the means for securing the primary support member to the second side of the wall. In another embodiment, the fall arrest device further comprises means for tuning a spacing between the means for securing the primary support member to the first side of the wall and the means for securing the primary support member to the second side of the wall.

### BRIEF DESCRIPTION OF THE DRAWINGS

FIG. 1 illustrates a functional view of a fall arrest device configured to safely provide a user access to an exterior portion of a tall structure, such as a multistory building.

FIG. 2 illustrates a perspective rear view of the primary support member of the fall arrest device.

FIGS. 3 and 4 illustrate a front perspective view of the primary support member of the fall arrest device secured to a doorway.

FIG. 5 illustrates a top view of the primary support member secured to a doorway formed by the wall having a first and second surface.

FIG. 6 illustrates a cross sectional side view of the primary support member.

FIG. 7 illustrates a top view of the primary support member.

FIG. 8 illustrates a cross sectional view of a portion of the primary support member.

FIG. 9 illustrates a user wearing a harness that is removeably coupled to a second end of the security line via a second security line connector attachment.

FIG. 10 illustrates a fall arrest device kit that houses together one or more fall arrest device components in a packaging for sale to a consumer in an unassembled state.

FIG. 11 illustrates a plurality of fall arrest device components comprising the fall arrest device kit.

FIG. 12 illustrates a method flowchart for securing a user working on a building from a fall.

### DETAILED DESCRIPTION

In the following description numerous specific details are set forth in order to provide a thorough understanding of the disclosure. However, one skilled in the art would recognize that the invention might be practiced without these specific details. In other instances, well known methods, procedures, and/or components have not been described in detail so as not to unnecessarily obscure aspects of the disclosure.

In the following description, certain terminology is used to describe certain features of one or more embodiments of the disclosure. For example, the term “security line” may include any rope, chain, and/or strap that when used with the fall arrest device is strong enough to secure a worker's weight from an accidental fall off of the side of a structure. Moreover, the terms “entryway” and/or “doorway” may be interchangeably used herein, and may be defined as a passage or an opening in a wall that provides access into a room. The entryway/doorway may be sized and shaped to accommodate a door, although it may not necessarily have a door attached to it.

### Overview

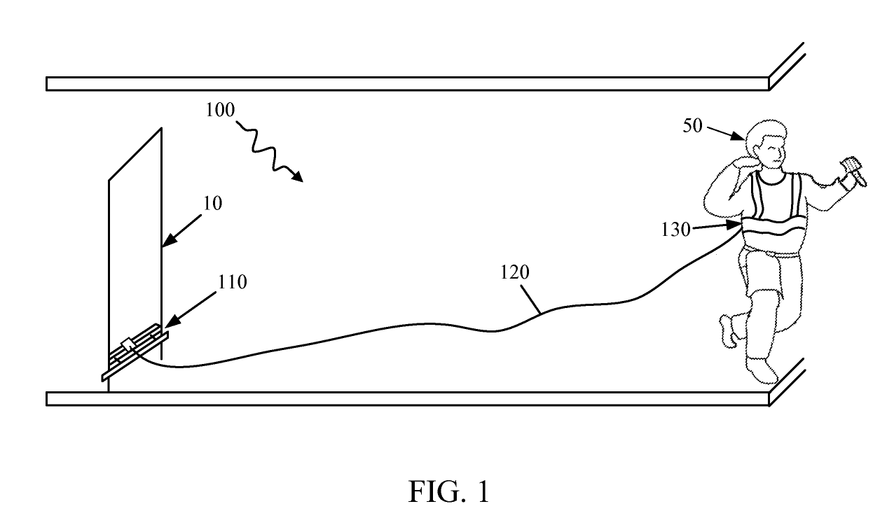

FIG. 1 illustrates a functional view of a novel fall arrest device 100 configured to safely provide a user 50, such as a construction worker, access to an exterior portion of a tall structure, such as a multistory building. The fall arrest device 100 secures the user 50 in case of an accidental fall. The fall arrest device 100 may comprise a primary support member 110, a security line 120, and a harness 130. The primary support member 110 may generally be any structure and/or member that removeably couples and secures to an interior portion of the building, such as a doorway 10. The primary support member 110 securely couples to one end of the security line 120. Another end of the security line 120 couples to the harness 130 that is worn by the user 50. In this fashion, the user 50 may safely lean over the edge of the building's higher story floors while working on, for example, the exterior surface of the building.

The primary support member 110 is securely, yet removeably, coupled to an interior portion of the building. Since the primary support member 110 is removeably coupled, it may be disengaged, moved, and reassembled at another location within the building to provide the user 50 access to other exterior portions of the building. In the preferred embodiment, the primary support member 110 may be rapidly disengaged/removed from one location and secured to another location within the building. This allows one or more users 50 secured to the fall arrest device 100 to work on many exterior portions of the building quickly, without the need to assemble multiple scaffolds, or operate a lift truck.

### Primary Support Member

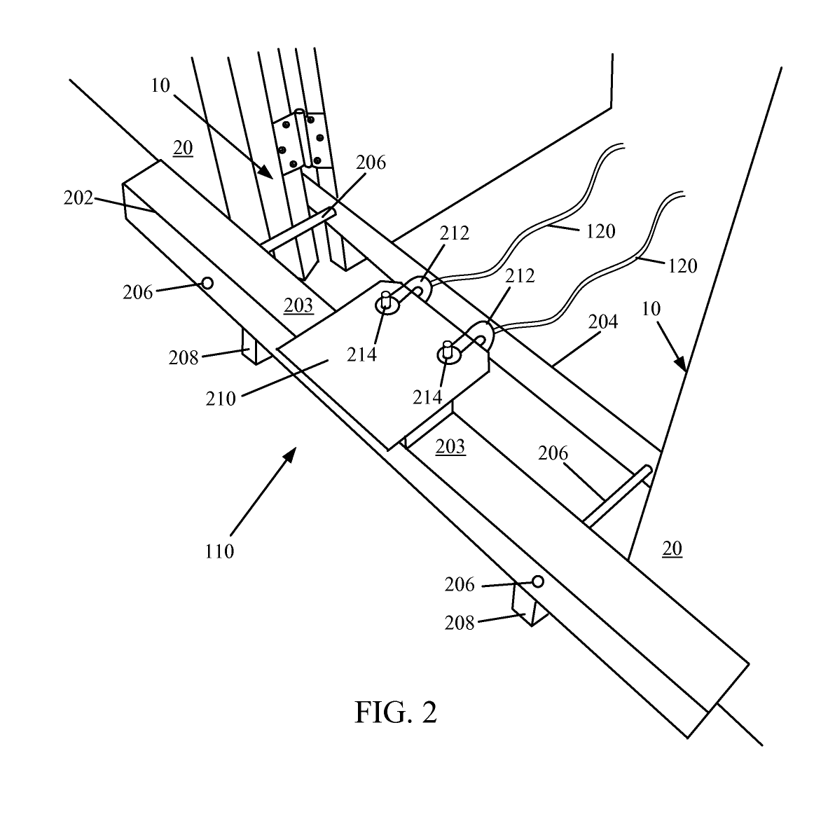

FIG. 2 illustrates a perspective rear view of one embodiment of the primary support member 110 of the fall arrest device 100. In this embodiment, the primary support member 110 is configured to removeably couple to a doorway 10 within a building. The primary support member 110 comprises a rear support member (also referred to herein as a “first support member”) 202, a front support member (also referred to herein as a “second support member”) 204, at least one connecting member 206, one or more rear support pedestals 208, a security line connector support mount 210, one or more security line connector 212, and/or one or more security line connector pivot members 214. In the preferred embodiment, the rear support member 202, the front support member 204, and the connecting member(s) 206 may be removeably coupled to one another to allow for easy assembly and disassembly of the primary support member 110 to the doorway 10.

The rear support member 202 secures the primary support member 110 against a first surface/side 20 of a wall having the doorway 10. The rear support member 202 may be a rod, tube, and/or bar made of high strength metal that can withstand great force before failing or deforming. For example, the rear support member 202 may be a metal tube or rod made according to ASTM A500 specifications. In one embodiment, the rear support member 202 may be 4″×4″ hollow tube made of a high strength aluminum alloy (e.g., Aluminum 6063-T6 or Aluminum 6061-T6 produced by ASM Aerospace Specification Metal Inc. of Pompano Beach, Fla.) having a thickness of 0.375″ and a square cross section. In other embodiments, the rear support member 202 may not be square but instead have another polygon cross section, such as but not limited to, triangular, quadrilateral, pentagon, hexagon, etc. In other embodiments, the rear support member 202 may be composed of other alloys and high strength materials, such as high strength plastics, have a solid or hollow construction, and/or have dimensions of varying height, width, and length to accommodate different applications and doorways.

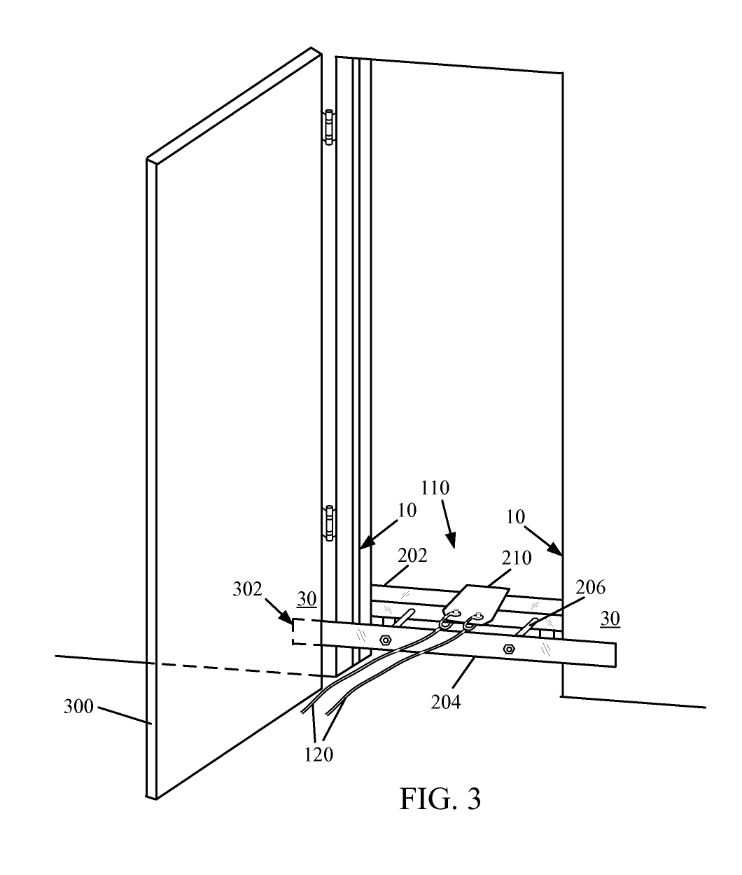

The front support member 204 secures the primary support member 110 against a second surface/side 30 (See FIG. 3) of the wall having the doorway 10, where the second surface/side 30 may be an opposite surface/side to the first surface/side 20. The front support member 204 may be a rod, tube, and/or bar made of high strength metal that can withstand great force before failing or deforming. For example, the front support member 204 may be a solid metal bar made according to ASTM A500 specifications, and be made of a high strength aluminum alloy (e.g., Aluminum 6063-T6 or Aluminum 6061-T6 produced by ASM Aerospace Specification Metal Inc. of Pompano Beach, Fla.) having a thickness of 0.375″ and a height of 3″. In other embodiments, the front support member 204 may not be a solid bar but instead be a hollow metal tube similar to the rear support member 202. In yet other embodiments, the front support member 204 may be composed of other alloys and high strength materials, such as high strength plastics, have a solid or hollow construction, and/or have dimensions of varying height, width, and length to accommodate different applications and doorways.

Referring to FIG. 2, the rear support member 202 and front support member 204 may be removeably secured to one another via one or more connecting members 206. The connecting members 206 may be fasteners, such as high strength bolts, that can be inserted through holes present in the rear support member 202 and the front support member 204 in order to removeably couple the support members 202, 204 together. In one example, the connecting members 206 may be 18-8 stainless steel bolts having a 0.625″ diameter. In other embodiments, the connecting members 206 may be different types of fasteners having different dimensions. The connecting members 206 are adjustable in order to tightly secure the rear support member 202 against the first surface 20 of the wall and simultaneously secure the front support member 204 against the second surface 30 (See. FIG. 3) of the wall, so that the primary support member 110 stays securely in place.

The rear support member 202 rests against the first surface/side 20 of the wall of the doorway 10. The first surface/side 20 of the wall is the side of the wall that faces in a direction opposite to that of the second surface/side 30 of the wall. The first surface/side 20 of the wall provides the necessary opposing force to prevent the rear support member 202 from moving and/or falling with the user 50 in the event of an accidental fall of the user 50. Thus, the rear support member 202 may be designed to be stronger and sturdier than the front support member 204 since in the event of a fall the rear support member 202 is responsible for securely keeping in place the primary support member 110 to the doorway 10.

Referring to FIG. 2, the rear support pedestals 208 are coupled to the bottom surface of the rear support member 202 and serve to elevate the rear support member 202 off of the ground. The rear support pedestals 208 may also be made of a high strength metal alloy or plastic. In one example, the rear support pedestals 208 are also hollow 4″ by 4″ square cross section metal pieces whose heights may vary depending on the amount of rear support member 208 lift desired. For example, the rear support pedestals 208 may be four (4) inches tall.

The primary support member 110 may also comprise a security line connector support mount 210. In one embodiment, the security line connector support mount 210 may be coupled to the rear support member 202. For example, the security line connector support mount 210 may be welded onto a top surface (also referred to herein as a “first surface”) 203 of the rear support member 202. If welded, the weld may be strong enough to support thousands of pounds of force without failing (e.g., 5000 lbs per security line 120). As another example, the security line connector support mount 210 may be bolted to the top surface 203 or coupled to another surface of the rear support member 202. In another embodiment, the security line connector support mount 210 may be coupled to the front support member 204. For example, if the front support member 204 is also a square tube similar to the rear support member 202, then the security line connector support mount 210 may be welded onto or bolted to the front support member 204 (e.g., a top surface of the front support member 204).

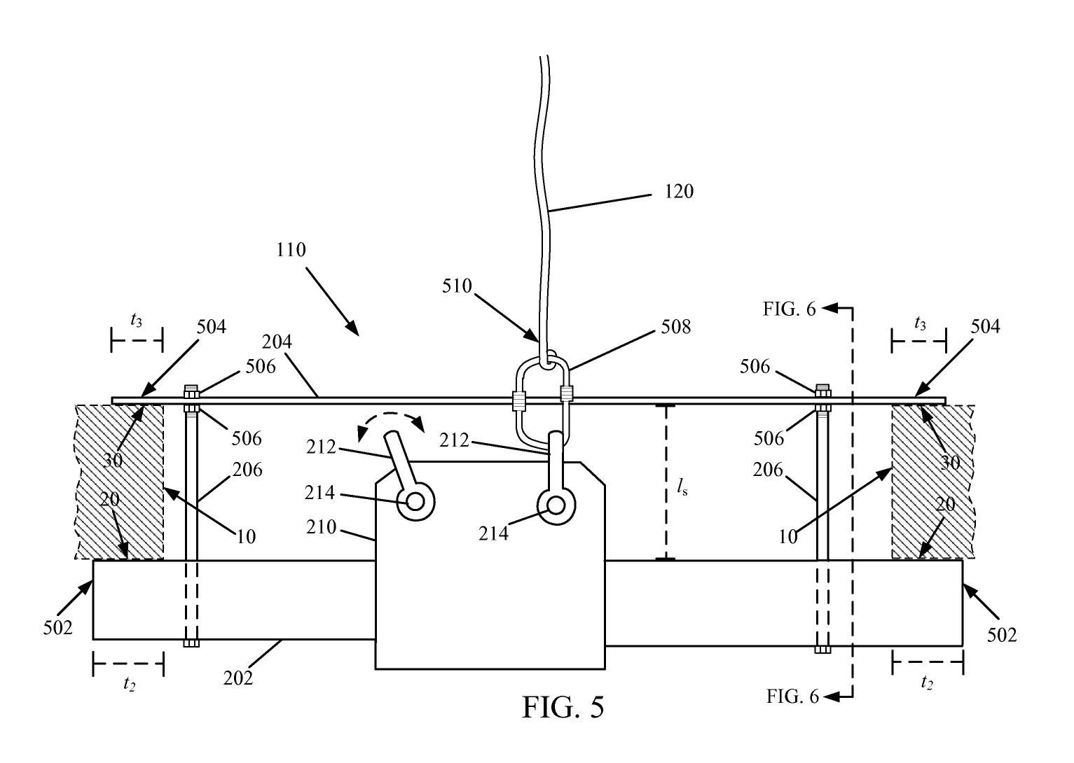

The security line connector support mount 210 secures one or more high strength metal security line connectors 212 that couple to the one or more security lines 120. The security line connectors 212 may be hooks, closed hooks, rings, and/or other connectors that allow the security line 120 to safely attach to the security line connector support mount 210. Each security line connector 212 may be attached to the security line connector support mount 210 through a security line connector pivot member 214 that allows the security line connectors 212 to pivot and swivel around (See dashed, curved arrow in FIG. 5). By having security line connectors 212 that swivel and pivot, a user 50 coupled to the primary support member 110 via the security line 120 has improved mobility. As one example, the security line connector pivot members 214 include bolts having a diameter of 0.625″. In other embodiments, the security line connector pivot members 214 may include other fasteners that allow for swiveling.

In the embodiment shown in FIG. 2, the primary support member 110 is adapted to independently secure two users through a security line connector support mount 210 having two pairs of security line connectors 212 and security line connector pivot members 214. Each security line connector 212 secures to an independent security line 120. In other embodiments, the primary support member 110 may feature one or more security line connectors 212 and security line connector pivot members 214 that each attach to at least one security line 120 to secure one or more users.

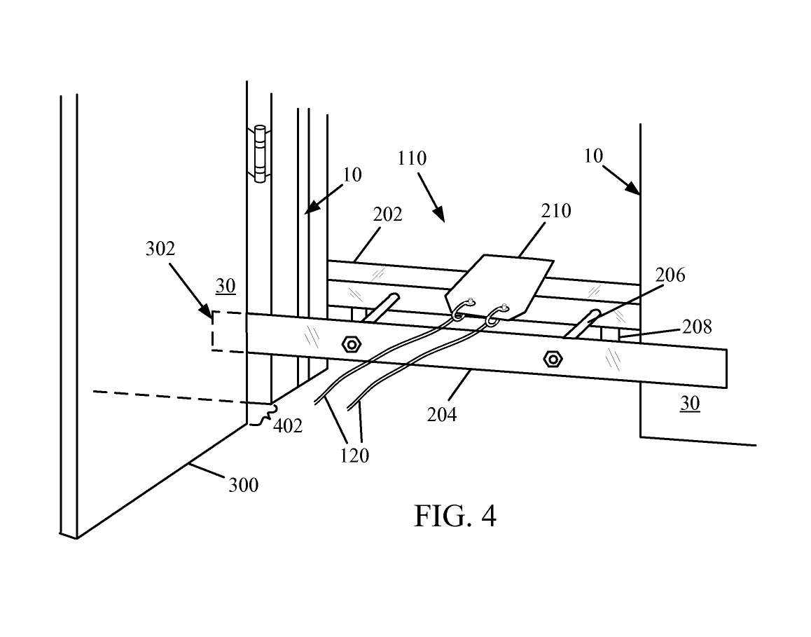

FIGS. 3 and 4 illustrate a front perspective view of the primary support member 110 of the fall arrest device 100 secured to a doorway 10 according to one embodiment. The front support member 204 secures the primary support member 110 against the second surface/side 30 of the wall having the doorway 10. FIGS. 3 and 4 show how a door 300 may be partially opened to allow the primary support member 110 to be secured to the doorway 10 despite the presence of the door 300. For example, one end 302 of the front support member 204 may pass through the space 402 between the open door 300 and the wall's second surface 30 in order to secure the front support member 204 against the wall's second surface 30.

FIG. 5 illustrates a top view of one embodiment of the primary support member 110 secured to a doorway 10 formed by the wall having the first surface/side 20 and the second surface/side 30. Two ends 502 of the rear support member 202 rest flush against the first surface 20 of the wall, while two ends 504 of the front support member 204 rest flush against the second surface 30 of the wall. To provide adequate stability and support, a portion of each end 502 of the rear support member 202 having a distance equal to t₂ may rest flush against the first surface 20 of the wall. Similarly, to provide adequate stability and support, a portion of each end 504 of the front support member 204 having a distance equal to t₃ may rest flush against the second surface 30 of the wall. In one embodiment, the distance t₂ may be equal to or greater than four (4) inches and the distance t₃ may be equal to or greater than two (2) inches. In another embodiment, the distance t₂ may be equal to or greater than six (6) inches and the distance t₃ may be equal to or greater than four (4) inches. The actual distances t₂ and t₃ may be determined based on the load the primary support member 110 needs to support. In one example, the primary support member 110 may be designed to support at least 5000 lbs of force per person (i.e., per security line) that it is adapted to support. For example, if the primary support member 110 includes two pairs of security line connectors 212, security line connector pivot members 214, and security lines 120, then the distances t₂ and t₃ may be adjusted to support a total force of 10,000 lbs.

The connecting members 206 may be adjusted via one or more connecting member fasteners 506, for example nuts, to accommodate doorways of various sizes. That is, the connecting member fasteners 506 may be adjusted to shorten or length the effective distance lₛ (also referred to herein as “spacing lₛ”) between the rear support member 202 and the front support member 204 in order to tightly secure the primary support member 110 to the doorway 10. The adjustability of the connecting members 206 and the fasteners 506 allows the primary support member 110 to be affixed to doorways having different depths. FIG. 5 also illustrates how, according to one example, a first security line connector attachment 508, such as a “D-ring,” may removeably couple a first end 510 of the security line 120 to one of the security line connectors 212. There may be one or more additional securement devices or rings (not shown) in between the first security line connector attachment 508 and the security line 120 for additional stability and security. A second security line connector attachment may be attached to other security line connectors 212 on the security line connector support mount 210. As indicated by the curved, dashed arrow, the security line connectors 212 can swivel and pivot to allow for greater user mobility.

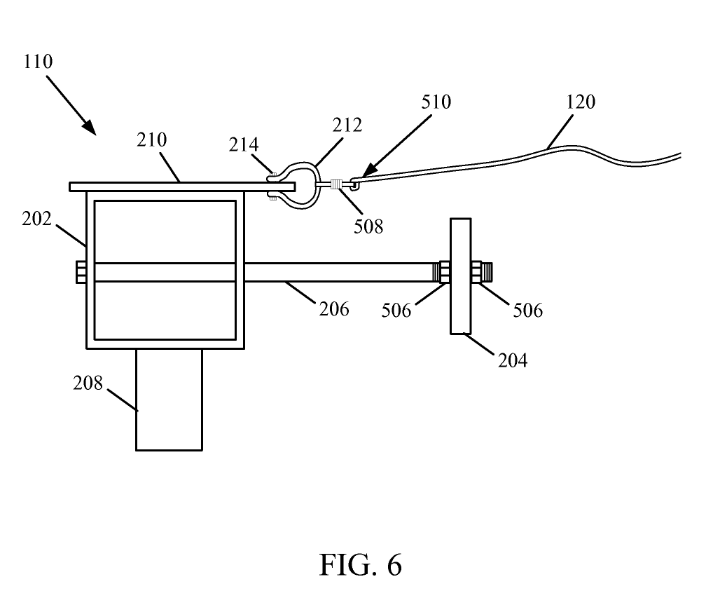

FIG. 6 illustrates a cross sectional side view of the primary support member 110 according to one embodiment. The first end 510 of the security line 120 is attached to the security line connector 212 via the security line connector attachment 508.

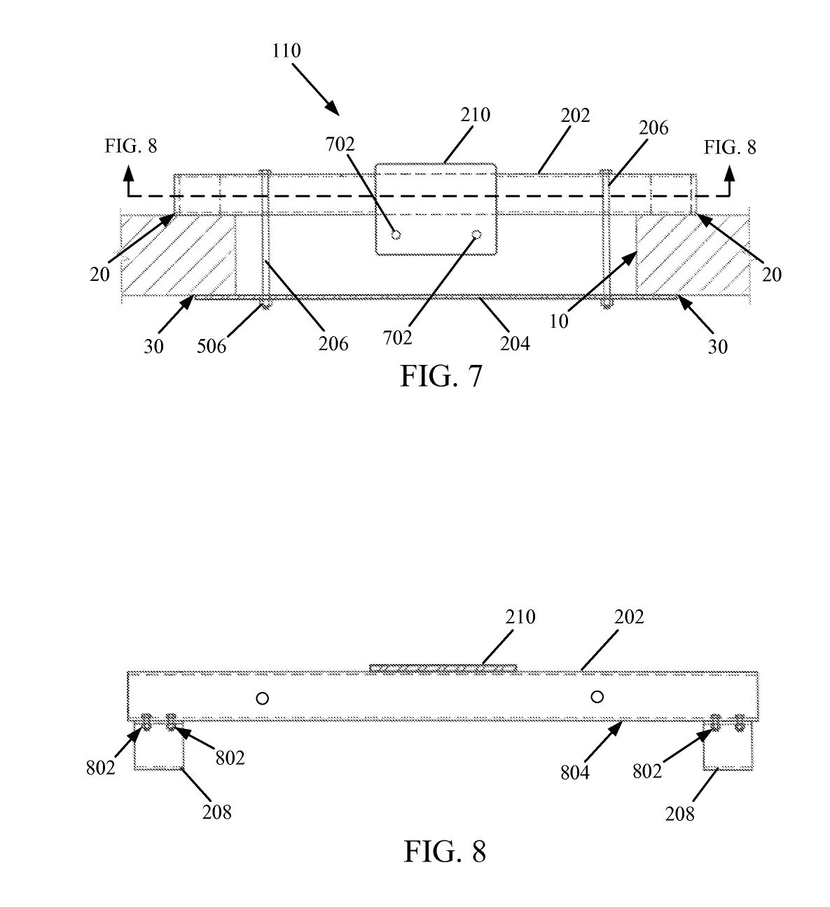

FIG. 7 illustrates a top view of the primary support member 110 according to one embodiment. The security line connectors 212 and security line connector pivot members 214 have been removed from view in FIG. 7 to illustrate the security line connector pivot member holes 702 that may allow a security line connector pivot member 214 (such as a bolt) to pass through.

FIG. 8 illustrates a cross sectional view of a portion of the primary support member 110 according to one embodiment. As shown, the rear support pedestals 208 may be removeably fastened to the bottom surface 802 of the rear support member 202 via one or more fasteners 804, such as but not limited to, bolts and nuts. In other embodiments, the pedestals 208 may be welded to the bottom surface 804 of the rear support member 202.

### Harness, Security Line, and Additional Embodiments

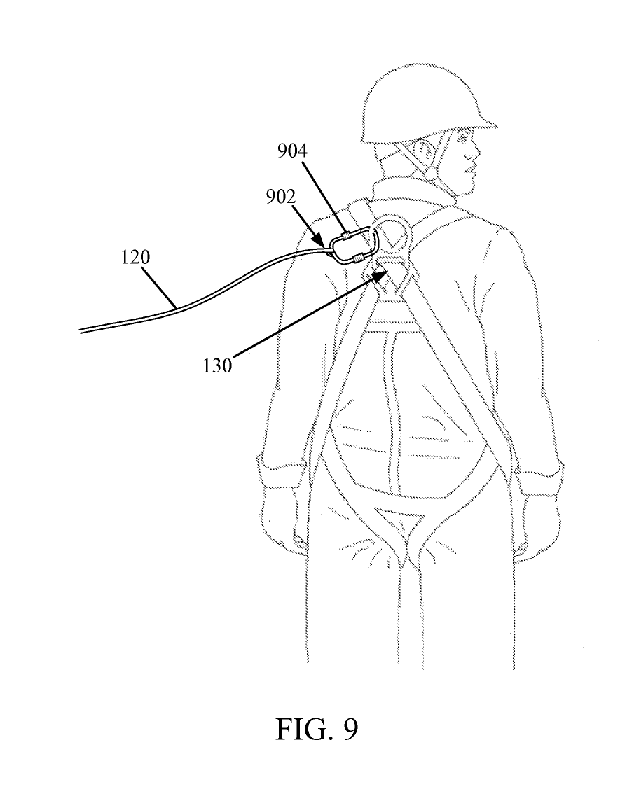

FIG. 9 illustrates a user wearing a harness 130 that is removeably coupled to a second end 902 of the security line 120 via a second security line connector attachment 904. The first end of the security line 120 (not shown in FIG. 9) may be secured to the primary support member. The harness 130 may be, for example, a harness adapted secure to a human user by securing the user around the waist, legs, and/or shoulders.

The security line(s) 120 of the fall arrest device 100 should be made of a high strength rope or fabric. For example, the security line 120 may be composed of a braided polyester, Kevlar®, nylon, and/or polypropylene material. The security line 120 selected for use with the fall arrest device 100 may be, in one example, tested to withstand a tension of 5000 lbs. In other applications where less strength is required, a security line 120 able to withstand 1000 lbs of tension may be used. In one embodiment, the security line 120 may be partially elastic so that in the event of a fall the security line 120 offers some elasticity and dampens the user's fall to a stop in a less abrupt fashion.

Generally, all parts and components used with the fall arrest device 100, including the first security line connector attachment 508, second security line connector attachment 902, the security line connector 212, the security line connector pivot member 214, and the harness 130 should be made of high strength materials that can safely secure the weight of a user and their equipment in the event of a fall. For example, any security line connector attachments 508, 902, security line connectors 212, security line connector pivot members 214, and harnesses 130 used with the fall arrest device 100 may be designed to withstand 1000 lbs or more of force, and in some embodiments, 5000 lbs or more of force.

In other embodiments, the fall arrest device 100 comprises a standalone support member in addition to or instead of the primary support member 110. The standalone support may not require any particular structure, such as a doorway, within the building to secure to. Rather, it may be very heavily weighted (e.g., weighs 1000 lbs or more) with, for example, a liquid such as water. If the user desires to move the fall arrest device from one location to another in the building, the liquid may be drained from the standalone support member to lighten it, and the fall arrest device may be easily moved to another location within the building.

### Fall Arrest Device Kit

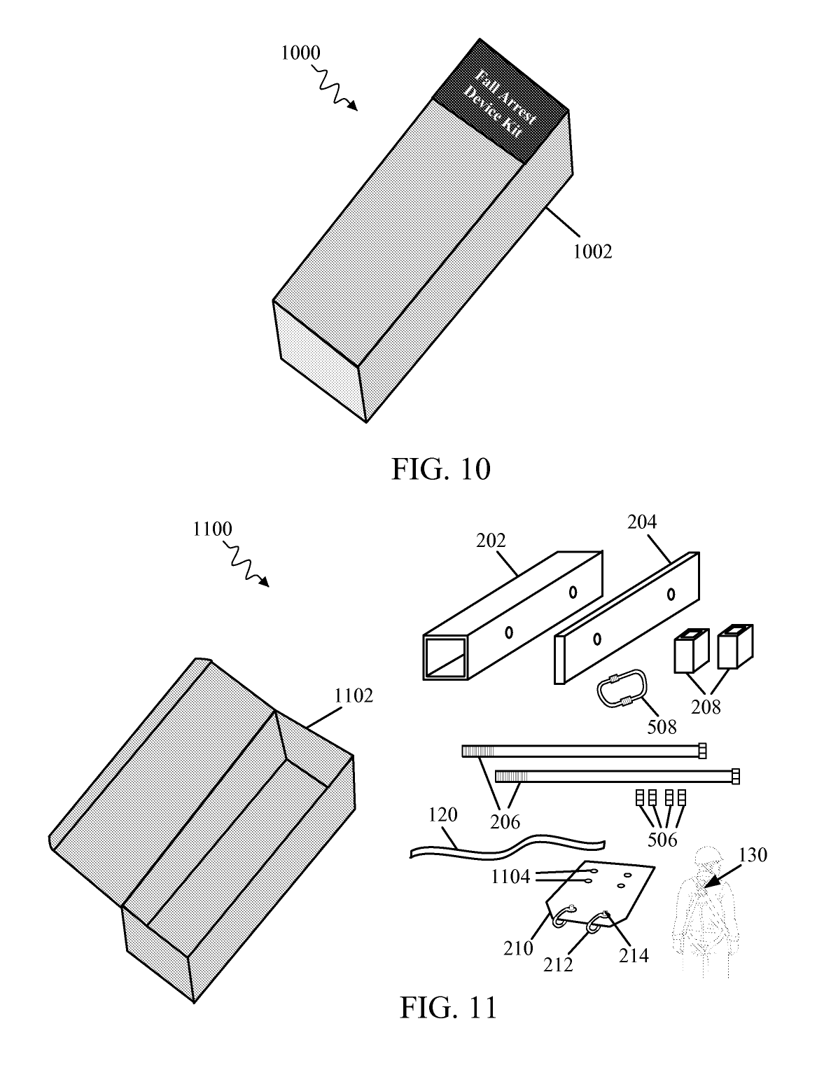

FIG. 10 illustrates a fall arrest device kit 1000 that houses together one or more fall arrest device components in a packaging 1002 for sale to a consumer in an unassembled state, or at least in a partially unassembled state. FIG. 11 illustrates, for example, some of the fall arrest device components 1100 that may be included in the fall arrest device kit 1000. The fall arrest device components 1100 may comprise, in one embodiment, the rear support member 202, the front support member 204, one or more of the connecting members 206, one or more of the pedestals 208, the security line connector support mount 210, one or more security line connecters 212, one or more security line connector pivot members 214, one or more connecting member fasteners 506, one or more security line connector adjusters 508, one or more security lines 120, one or more harnesses 130, and/or a carrying case 1102. The security line connector support mount 210 may feature holes 1104 to allow it to be bolted onto the rear support member 202.

The carrying case 1102 is configured to store the fall arrest device components 1100, and may be a sturdy container with a handle, or a flexible bag such as a duffle bag. The carrying case 1102 allows for increased portability of the fall arrest device 100 since all the necessary components of the fall arrest device 100 may be included in the carrying case 1102 for ease of transportation from one location in a building to another.

### Method of Securing a User

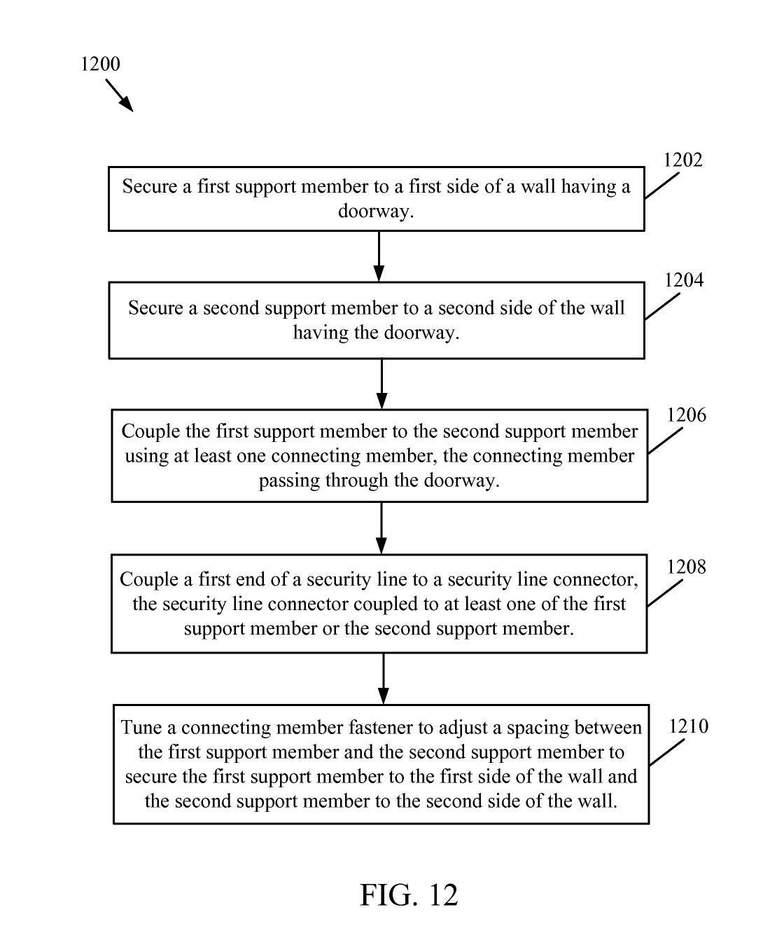

FIG. 12 illustrates a flowchart for securing a user working on a building from falling according to one embodiment. First, a first support member is secured to a first side of a wall having a doorway 1202. Next, a second support member is secured to a second side of the wall having the doorway 1204. Next, the first support member is coupled to the second support member using at least one connecting member, the connecting member passing through the doorway 1206. Next, a first end of a security line may be coupled to a security line connector, the security line connector coupled to at least one of the first support member or the second support member 1208. Then, a connecting member fastener may be tuned to adjust a spacing between the first support member and the second support member to secure the first support member to the first side of the wall and the second support member to the second side of the wall 1210.

One or more of the components and functions illustrated in FIGS. 1-12 may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A fall arrest device for securing a user, the fall arrest device comprising:
a primary support member adapted to couple to a doorway;
at least one security line having a first end adapted to couple to the primary support member; and
at least one harness adapted to couple to a second end of the security line.

2. The fall arrest device of claim 1, wherein the primary support member is adapted to removeably couple to the doorway.

3. The fall arrest device of claim 1, wherein the first end of the security line is adapted to removeably couple to a security line connector.

4. The fall arrest device of claim 3, wherein the security line connector swivels about a security line connector pivot member.

5. The fall arrest device of claim 1, wherein the primary support member comprises:
a first support member adapted to secure the primary support member to a first surface of a wall of the doorway;
a second support member adapted to secure the primary support member to a second surface of the wall of the doorway; and
at least one connecting member adapted to removeably couple the first support member and the second support member to each other.

6. The fall arrest device of claim 5, further comprising:
a security line connector support mount having at least one security line connector, the security line connector support mount coupled to at least one of the first support member or the second support member, the security line connector coupled to the first end of the security line.

7. The fall arrest device of claim 5, wherein the connecting member is further adapted to adjust a spacing between the first support member and the second support member to secure the primary support member to the doorway.

8. The fall arrest device of claim 7, wherein the connecting member includes a connecting member fastener that adjusts the spacing between the first support member and the second support member.

9. The fall arrest device of claim 1, wherein the first support member is hollow and a cross section of the first support member has at least three sides.

10. A primary support member for a fall arrest device, the primary support member comprising:
a first support member adapted to secure the primary support member to a first surface of a wall of a doorway;
a second support member adapted to secure the primary support member to a second surface of the wall of the doorway; and
at least one connecting member adapted to removeably couple the first support member and the second support member to each other, and the primary support member is adapted to removeably couple to the doorway.

11. The primary support member of claim 10, wherein the connecting member is further adapted to adjust a spacing between the first support member and the second support member to secure the primary support member to the doorway.

12. The primary support member of claim 11, wherein the connecting member includes a connecting member fastener that adjusts the spacing between the first support member and the second support member.

13. The primary support member of claim 10, further comprising:
a security line connector support mount having at least one security line connector, the security line connector support mount coupled to at least one of the first support member or the second support member, the security line connector adapted to couple to a first end of a security line.

14. The primary support member of claim 13, wherein the security line connector swivels about a security line connector pivot member.

15. The primary support member of claim 10, wherein at least a first end of the second support member is adapted to pass through a space between a door associated with the doorway and the second surface of the wall.

16. A fall arrest device kit, the kit comprising:
a plurality of fall arrest device components packaged together in an at least partially unassembled state for sale to consumers, wherein the fall arrest device components comprise:
a first support member adapted to secure to a first surface of a wall of a doorway;
a second support member adapted to secure to a second surface of the wall of the doorway; and
at least one connecting member adapted to removeably couple the first support member and the second support member to each other.

17. The kit of claim 16, wherein the fall arrest device components further comprise:
a security line having a first end adapted to couple to a security line connector; and
a harness adapted to couple to a second end of the security line.

18. A method of securing a user, the method comprising:
securing a first support member to a first side of a wall having a doorway;
securing a second support member to a second side of the wall having the doorway; and
coupling the first support member to the second support member using at least one connecting member, the connecting member passing through the doorway.

19. The method of claim 18, further comprising:
coupling a first end of a security line to a security line connector, the security line connector coupled to at least one of the first support member or the second support member.

20. The method of claim 18, further comprising:
tuning a connecting member fastener to adjust a spacing between the first support member and the second support member to secure the first support member to the first side of the wall and the second support member to the second side of the wall.
